(19) United States
(12) Patent Application Publication
(10) Pub. No.: US 2013/0268102 A1
(43) Pub. Date: Oct. 10, 2013

(54) AUDIO RECOGNITION SYSTEM AND METHOD

(71) Applicant: HON HAI PRECISION INDUSTRY CO., LTD., New Taipei (TW)

(72) Inventor: YI-AN CHEN, New Taipei (TW)

(73) Assignee: HON HAI PRECISION INDUSTRY CO., LTD., New Taipei (TW)

(21) Appl. No.: 13/711,392

(22) Filed: Dec. 11, 2012

(30) Foreign Application Priority Data
Apr. 10, 2012 (TW) 101112557

(51) Int. Cl. G06F 17/28

(52) U.S. Cl. CPC G06F 17/28
USPC 700/94

(57) ABSTRACT

An audio recognition system includes a storage, a display, an audio player, an audio receiving module, an audio converting module, an audio database module, an audio recognition module, and a control chip. The audio receiving module receives audio signal. The audio converting module converts the audio signal to audio receiving data and stores the audio receiving data to the storage. The audio database module stores different character data and audio data. The audio recognition module finds character receiving data, first audio response data, first character response data, and sends the character receiving data and the first character response data to the control chip. The control chip displays the character receiving data and the first character response data via the display, and plays the first audio response data via the audio player.

### BACKGROUND

1. Technical Field

The disclosure generally relates to an audio recognition system and method.

2. Description of Related Art

A lot of people have pets, such as cats or dogs. However, people usually cannot communicate with their pets, creating a missed connection between the pets and the people.

Thus, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an audio recognition system in accordance with an embodiment.

FIG. 2 is a flow chart of an audio recognition method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

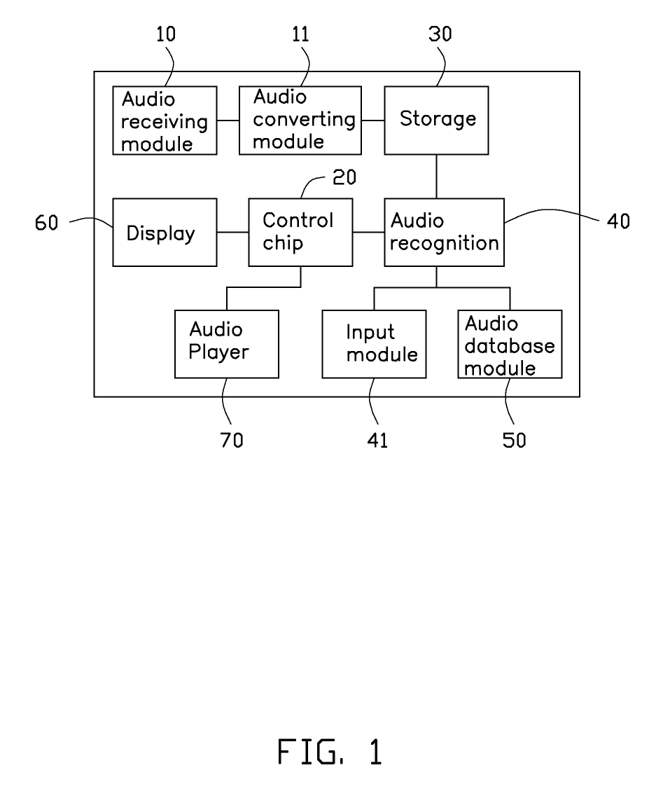

FIG. 1 shows one embodiment of an audio recognition system. The audio recognition system includes an audio receiving module 10, an audio converting module 11, a control chip 20, a storage 30, an audio recognition module 40, an input module 41, an audio database module 50, a display 60, and an audio player 70. In one embodiment, the audio receiving module 10 is a microphone, and the audio player 70 is a loudspeaker.

The audio receiving module 10 is connected to the control chip 20, the audio recognition module 40 is connected to the control chip 20. The storage 30 is connected to the audio recognition module 40. The audio database module 50 is connected to the control chip 20. The display 60 is connected to the control chip 20. The audio player 70 is connected to the control chip 20. The input module 41 is connected to the audio recognition module 40.

The audio database module 50 stores different receiving character data corresponding to different audio receiving data, audio response data, and different response character data corresponding to different audio response data. The audio receiving module 10 is configured to receive audio signal. The audio converting module 11 is configured to convert the audio signal to audio receiving data. The storage 30 is configured to store the audio receiving data. The audio recognition module 40 is configured to find character receiving data corresponding to the audio receiving data, audio response data corresponding to the audio receiving data, and character response data corresponding to the audio receiving data, and send them to the control chip 20. The control chip 20 is configured to display the character receiving data and the character response data on the display 60. The input module 41 is configured to send a selection determined by the user to the audio recognition module 40. The audio recognition module 40 is further configured to send audio response data corresponding to the selection to the control chip 20 after receiving the selection. The control chip 20 is further configured to play the audio response data via the audio player 70.

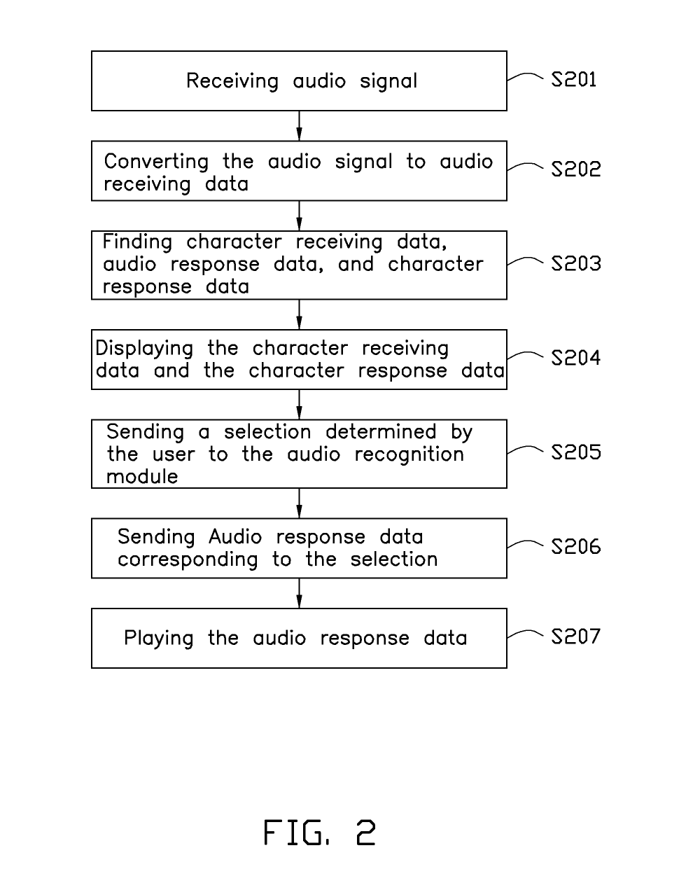

FIG. 2 shows an embodiment of an audio recognition method. The audio recognition method includes the following steps.

S201, the audio receiving module 10 receives audio signal.

S202, the audio converting module 11 converts the audio signal to audio receiving data and stores the audio receiving data to the storage 30.

S203, the audio recognition module 40 finds character receiving data corresponding to the audio receiving data, audio response data corresponding to the audio receiving data, and character response data corresponding to the audio response data from the audio database module 50, and sends the character receiving data and the character response data to the control chip 20.

S204, the control chip 20 displays the character receiving data and the character response data on the display 60.

S205, the input module 41 sends a selection of one particular character response data to be made by the user to the audio recognition module 40.

S206, the audio recognition module 40 sends the audio response data, corresponding to the particular character response data, to the control chip 20.

S207, the control chip 20 plays back the audio response data via the audio player 70.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An audio recognition system, comprising:
a storage;
a display;
an audio player;
an audio receiving module, the audio receiving module is configured to receive audio signal;
an audio converting module, the audio converting module is configured to convert the audio signal to audio receiving data and store the audio receiving data to the storage;
an audio database module, the audio database module is configured to store different character data and audio data;
an audio recognition module, the audio recognition module is configured to find character receiving data, first audio response data, first character response data; and
a control chip, the control chip is configured to receive the character receiving data and the first character response data from the audio recognition module, and to display the character receiving data and the first character response data via the display and play the first audio response data via the audio player.

2. The audio recognition system of claim 1, further comprising an input module, wherein the audio recognition module is further configured to find second audio response data corresponding to the audio receiving data and second character response data, corresponding to the second audio response data; the input module is configured to receive a selection, of the first character response data or the second character response data, determined by a user; and the control chip is further configured to display the second character response data via the display, and play the first audio response data or the second audio response data via the audio player.

3. The audio recognition system of claim 1, wherein the audio receiving module is a microphone.

4. The audio recognition system of claim 1, wherein the audio player is a loudspeaker.

5. An audio recognition method, comprising:
providing an audio recognition system, the audio recognition system comprises an audio receiving module, an audio converting module, an audio recognition module, a control chip, a display, and an audio player;
receiving an audio signal via the audio receiving module;
converting the audio signal to audio receiving data and storing the audio receiving data in a storage via the audio converting module;
finding character receiving data corresponding to the audio receiving data, first audio response data response to the audio receiving data, and first character response data corresponding to the first audio response data via the audio recognition module; and sending the first character receiving data and the first character response data to the control chip; and
displaying, via the control chip, the character receiving data and the first character response data on the display, and playing the first audio response data via the audio player.

6. The audio recognition method of claim 5, further comprising:
finding a second audio response data response to the audio receiving data and second character response data corresponding to the second audio response data;
receiving a selection, of the first character response data or the second character response data, determined by a user via an input module; and
displaying the second character data via the display, and playing the first audio response data or the second audio response data via the audio player.

7. The audio recognition method of claim 5, wherein the audio receiving module is a microphone.

8. The audio recognition method of claim 5, wherein the audio player is a loudspeaker.
